(19) United States
(12) Patent Application Publication
(10) Pub. No.: US 2026/0201114 A1
(43) Pub. Date: Jul. 16, 2026

(54) REPROCESSABLE AND DEGRADABLE BISMALEIMIDE RESIN

(71) Applicant: SOOCHOW UNIVERSITY, Suzhou (CN)

(72) Inventors: Aijuan GU, Suzhou (CN); Guozheng LIANG, Suzhou (CN); Li YUAN, Suzhou (CN)

(21) Appl. No.: 19/447,974

(22) Filed: Jan. 13, 2026

(30) Foreign Application Priority Data
Jan. 16, 2025 (CN) 202510067679.4

(51) Int. Cl. C08G 63/91; C08G 18/10; C08G 73/12; C08G 73/14

(52) U.S. Cl. CPC C08G 63/912; C08G 18/10; C08G 73/121; C08G 73/14

(57) ABSTRACT

The invention discloses a remodelable degradable bismaleimide resin and a preparation method thereof, which are prepared from 4,4-dithiodiphenylamine bismaleimide (AM), 4-diallyloxy diphenyl Disulfide (DS) and phenolphthalein polyaryletherketone. The bismaleimide resin prepared by the invention not only has excellent heat resistance, but also can realize remolding under the hot-pressing condition, realizes faster degradation in a conventional solvent, and can realize closed-loop recovery by evaporating the degradation solution and heating and pressurizing the solvent, thereby overcoming the defects that the bismaleimide resin containing reversible covalent bonds is difficult to have high heat resistance, remolding and degradability, and providing a new resin and preparation strategy for realizing the sustainable development of heat-resistant thermosetting resin

This application claims priority to Chinese Patent Application No. 202510067679.4, filed on Jan. 16, 2025, which is incorporated by reference for all purposes as if fully set forth herein.

### TECHNICAL FIELD

The present invention relates to a thermosetting resin and its preparation method, particularly to a reprocessable and degradable bismaleimide resin and its preparation, reprocessing, degradation and recovery method, which belongs to the field of functional polymer materials.

### BACKGROUND TECHNOLOGY

Bismaleimide (BMI) resin, a typical heat-resistant thermosetting material, has been extensively utilized in cutting-edge sectors including aerospace, transportation, and information technology, etc. As a thermosetting resin, BMI resin is difficult to be repaired and recycled after curing due to their “insoluble and infusible” nature. Consequently, the research and development of reprocessable and degradable thermosetting resins has attracted significant attention in recent years. Through reversible covalent bonding technology, researchers have successfully achieved the reprocessing and degradation of various thermosetting resins. However, studies on BMI resins remain in the early stage.

To date, there are scarcely any reports on the simultaneous realization of degradable properties in reprocessable bismaleimide resins. One existing technology disclosed the preparation of BMI resins through copolymerization of aryl allyl ether compounds containing disulfide bonds with 4,4′-bismaleimidodiphenylmethane (BDM). Although these resins exhibited high crosslinking density and reversible dynamic covalent bonds, they failed to achieve degradation (see: Research on High-Performance Intrinsic Flame Retardant Bismaleimide Resins Containing Disulfide Bonds and Their Reprocessing). Another existing technology utilized copolymerization of BDM, 4-aminophenyl sulfide, and aliphatic polyether diamine to obtain reprocessable BMI resins, which demonstrated only 8% reprocessing efficiency and no degradation was reported (see: Reprocessable Bismaleimide-Diamine Thermosets Based on Disulfide Bonds).

Existing technology CN118930851A prepared a BMI resin degradable in nitric acid aqueous solution by copolymerizing a triamine containing an acid-sensitive hexahydrotriazine ring structure, 2,2-bis[4-(4-aminophenoxy)phenyl] propane, and BDM. However, no reprocessing capability was mentioned, and the resin preparation required the use of solvents such as DMF. Another existing technology disclosed a degradation method for BMI resin, which required 12 hours in a toluene solution containing excessive mercapto (dimethoxymethyl) silane (DP970) to achieve complete degradation. (see: Aging-Resistant, High-Strength, Reprocessable, and Recyclable Silicones through Dynamic Thiol-Maleimide Chemistry).

In summary, there are few reports on the development of reprocessable and degradable bismaleimide resin in existing technologies. Moreover, the BMI resins reported in current technologies struggle to simultaneously achieve high heat resistance, reprocessability, and degradability. Therefore, the research and development of novel BMI resins with high heat resistance and reprocessable/degradable properties holds significant application value.

### SUMMARY OF INVENTION

Based on the deficiencies of existing technologies, this invention provides a highly heat-resistant, reprocessable and degradable bismaleimide resin as well as a preparation method thereof.

To achieve the above objectives, the technical solution adopted by this invention is as follows.

A reprocessable and degradable bismaleimide resin, wherein the preparation raw materials include 4,4′-diallyloxy diphenyl disulfide, phenolphthalein polyarylether ketone, and 4,4′-dithiodianiline bismaleimide.

Preferably, the raw materials for preparing the reprocessable and degradable bismaleimide resin of the present invention are 4,4′-diallyloxy diphenyl disulfide, phenolphthalein polyarylether ketone, and 4,4′-dithiodianiline bismaleimide.

In the present invention, the mass ratio of the monomer to phenolphthalein polyarylether ketone is 1:(0.05-0.2). The monomers are 4,4′-diallyloxy diphenyl disulfide and 4,4′-dithiodianiline bismaleimide, and the molar ratio of 4,4′-diallyloxy diphenyl disulfide to 4,4′-dithiodianiline bismaleimide is (0.5-1): 1.

Preferably, the molar ratio of 4,4′-diallyloxy diphenyl disulfide to 4,4′-dithiodianiline bismaleimide is (0.6-0.9): 1.

In a further preferred embodiment, the molar ratio of 4,4′-diallyloxy diphenyl disulfide to 4,4′-dithiodianiline bismaleimide is (0.7-0.9): 1. For example, the molar ratio of 4,4′-diallyloxy diphenyl disulfide to 4,4′-dithiodianiline bismaleimide is 0.8:1, 0.85:1, 0.86:1, 0.9:1, or any ratio within the stated range.

The present invention discloses a preparation method of the aforementioned reprocessable and degradable bismaleimide resin, comprising the following steps: mixing the raw materials for preparing the reprocessable and degradable bismaleimide resin, followed by curing to obtain the reprocessable and degradable bismaleimide resin.

In the present invention, phenolphthalein polyarylether ketone and 4,4′-diallyloxy diphenyl disulfide were mixed at 100-180° C., then 4,4′-dithiodianiline bismaleimide was added and mixed at 100-150° C., and then cured to obtain a reprocessable and degradable bismaleimide resin.

Preferably, the phenolphthalein polyarylether ketone and 4,4′-diallyloxy diphenyl disulfide were mixed and stirred at 120 to 170° C. for 5 to 60 minutes. Subsequently, 4,4′-dithiodianiline bismaleimide was added, and the mixture was further mixed and stirred at 110 to 140° C. for 5 to 45 minutes, followed by curing to obtain the reprocessable and degradable bismaleimide resin.

In the present invention, the curing temperature ranged from 150 to 240° C., with a duration of 8 to 15 hours, and the curing process utilized the stepwise heating. Preferably, during the stepwise heating, the temperature difference between adjacent steps is 20 to 30° C., with a duration of 1 to 3 hours.

The present invention discloses a method for preparing a prepolymer of a reprocessable and degradable bismaleimide resin, comprising the following steps: mixing raw materials for preparing the reprocessable and degradable bismaleimide resin to obtain the prepolymer of the reprocessable and degradable bismaleimide resin; The raw materials for preparing the reprocessable and degradable bismaleimide resin include 4,4′-diallyloxy diphenyl disulfide, phenolphthalein polyarylether ketone, and 4,4′-dithiodianiline bismaleimide. Preferably, the raw materials for preparing the reprocessable and degradable bismaleimide resin are 4,4′-diallyloxy diphenyl disulfide, phenolphthalein polyarylether ketone, and 4,4′-dithiodianiline bismaleimide.

The present invention discloses the application of the aforementioned reprocessable and degradable bismaleimide resin in the preparation or as a bismaleimide resin material. The bismaleimide resin material can be the bismaleimide resin material with inorganic fillers, the bismaleimide resin materials compounded with reinforcing materials, and the bismaleimide resin materials compounded with other resins. The reinforcing materials comprise fibrous materials such as fibers or fiber fabrics (e.g., fiber cloth).

The present invention discloses a reprocessing method for the reprocessable and degradable bismaleimide resin. The method includes the following step: subjecting the crushed reprocessable and degradable bismaleimide resin to hot pressing to achieve reprocessing of the resin.

The present invention discloses a degradation method for the reprocessable and degradable bismaleimide resin. The method includes the following steps: subjecting the reprocessable and degradable bismaleimide resin to a solvent to achieve its degradation.

The present invention discloses a recycling method for the reprocessable and degradable bismaleimide resin. The method includes the following steps: degrading the resin in a solvent, followed by solvent removal to achieve the recycling.

Furthermore, the recycled resin can be subjected to hot pressing to produce bismaleimide resin materials.

Compared with the prior art, the present invention has the following beneficial effects:

1. The bismaleimide (BMI) resin prepared in the present invention uses 4,4′-dithiodianiline bismaleimide (AM), 4,4′-diallyloxy diphenyl disulfide (DS), and phenolphthalein polyarylether ketone as raw materials, and possesses reprocessability, degradability, and high heat resistance (with a Tg of no less than 220° C.).

2. The bismaleimide resin prepared by the invention exhibits a high dynamic bond content, which facilitates resin reprocessing at lower temperatures, endowing the BMI resin with reprocessability and reducing resource waste.

3. The BMI resin prepared by the invention exhibits strong chain segment mobility, possesses degradability, and improves degradation efficiency.

4. The reprocessable and degradable bismaleimide resin prepared by the present invention exhibits high mechanical properties, particularly high flexural strength. This is attributed not only to the high mechanical properties of the BMI resin but also to the presence of phenolphthalein polyarylether ketone, which imparts both high rigidity and excellent toughness to the resin.

### BRIEF DESCRIPTION OF THE DRAWINGS

FIG. 1 shows the synthesis reactions and chemical structural formulas of 4,4′-dithiodianiline bismaleimide and 4,4′-diallyloxy diphenyl disulfide according to the present invention.

FIG. 2 shows the 1H NMR and 13C NMR spectra of the 4,4′-dithiodianiline bismaleimide of the present invention.

FIG. 3 shows the mass spectrum of the 4,4′-dithiodianiline bismaleimide of the present invention.

FIG. 4 shows the 1H NMR and 13C NMR spectra of the 4,4′-diallyloxy diphenyl disulfide of the present invention.

FIG. 5 shows the mass spectrum of the 4,4′-diallyloxy diphenyl disulfide of the present invention.

FIG. 6 shows the loss tangent (Tan δ)-temperature curves of the reprocessable and degradable bismaleimide resin prepared in Embodiments 1~4 of the present invention, with a heating rate of 3° C./min and a frequency of 1 Hz.

FIG. 7 shows the thermogravimetric analysis (TGA) curves of the reprocessable and degradable bismaleimide resin prepared in Embodiments 1~4 of the present invention, with a heating rate of 10° C./min under nitrogen atmosphere.

FIG. 8 shows the bending strength histogram of the reprocessable and degradable bismaleimide resin prepared in Examples 1~4 and Comparative Example 1 of the present invention.

FIG. 9 shows the stress relaxation curves of the reprocessable and degradable bismaleimide resin prepared in Embodiments 1~4 and Comparative Example 1 of the present invention.

FIG. 10 is a digital photograph of the reprocessing process of the reprocessable and degradable bismaleimide resin prepared in Embodiment 1 of the present invention.

FIG. 11 shows the bending strength histogram of the reprocessable and degradable bismaleimide resin prepared in Embodiments 1~4 of the present invention after reprocessing.

FIG. 12 shows the thermogravimetric analysis (TGA) curves of the reprocessable and degradable bismaleimide resin prepared in Embodiments 1~4 of the present invention after reprocessing, with a heating rate of 10° C./min under nitrogen atmosphere.

FIG. 13 shows digital images of the reprocessable and degradable bismaleimide resin prepared in Embodiments 1~4 and Comparative Examples 1 and 2, before and after degradation.

FIG. 14 shows the FTIR spectra of the degradation residues of bismaleimide resin prepared in Embodiments 1~4 of the present invention and phenolphthalein polyarylether ketone.

FIG. 15 shows the FTIR spectra of the bismaleimide resin and its degradation product (deBMI) prepared in Embodiment 1 of the present invention.

FIG. 16 shows digital photographs of the degradation and recycling of the bismaleimide resin prepared in Embodiment 1 of the present invention.

FIG. 17 shows the loss tangent (Tan δ)-temperature curve of the recycled bismaleimide resin (R-deBMI) prepared in Embodiment 1 of the present invention, with a heating rate of 3° C./min and a frequency of 1 Hz.

### SPECIFIC IMPLEMENTATION METHODS

The present invention discloses a preparation method for the reprocessable and degradable bismaleimide resin, comprising the following steps:

4,4′-dithiodianiline bismaleimide (AM) was obtained by acylation reaction of maleic anhydride and 4,4′-diaminodiphenyl disulfide.

4,4′-diallyloxy diphenyl disulfide (DS) was obtained by substitution reaction of 3-bromopropene and 4,4′-dihydroxydiphenyl disulfide.

The 4,4′-diallyloxy diphenyl disulfide was mixed with phenolphthalein polyarylether ketone, then 4,4′-dithiodianiline bismaleimide was added, and the mixture was cured to obtain a reprocessable and degradable bismaleimide resin.

In the above technical scheme, phenolphthalein polyarylether ketone and 4,4′-diallyloxy diphenyl disulfide were mixed and stirred at 140-150° C. for 10-20 minutes, then 4,4′-dithiodianiline bismaleimide was added and mixed and stirred at 120-130° C. for 10-25 minutes, and then was cured to obtain the reprocessable and degradable bismaleimide resin.

In the above technical scheme, the mass ratio of the two monomers (4,4′-diallyloxy diphenyl disulfide and 4,4′-dithiodianiline bismaleimide) to phenolphthalein polyarylether ketone was 1:(0.05-0.2). The curing reaction temperature was 150-240° C., and the curing reaction time was 10-12 hours. The curing reaction was carried out by stepwise heating.

The reprocessing method for recycling of the reprocessable and degradable bismaleimide resin of this invention comprises the following steps: The crushed resin was pressurized and heated to complete the reprocessing process. Crushing was a conventional technique, such as mechanical pulverization. In this invention, resin after degradation may also be utilized—a technical effect that is unforeseeable in the prior art.

The degradation method of the reprocessable and degradable bismaleimide resin of the present invention comprises the following steps: placing the reprocessable and degradable bismaleimide resin in a mixed solution of N,N-dimethylformamide (DMF) and β-mercaptoethanol to achieve its degradation.

The recycling method for the reprocessable and degradable bismaleimide resin comprises the following steps: the resin was degraded in a mixed solution of N,N-dimethylformamide (DMF) and β-mercaptoethanol, followed by solvent removal to obtain resin powder, thereby achieving the recycling of the bismaleimide resin.

Furthermore, the powder was reheated and pressurized to achieve the reprocessing of the recycled reprocessable and degradable bismaleimide resin.

The technical solution of the present invention is further described with reference to the accompanying drawings and embodiments. The raw materials used in the invention are commercially available products, and the specific preparation procedures as well as performance testing are conventional techniques.

Phenolphthalein polyether ketone (cPEK, with a number-average molecular weight of 40,000), sourced from Xuzhou Aerospace Materials Engineering Plastics Factory, has the following chemical structure:

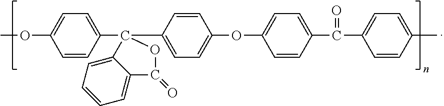

### Synthetic Examples

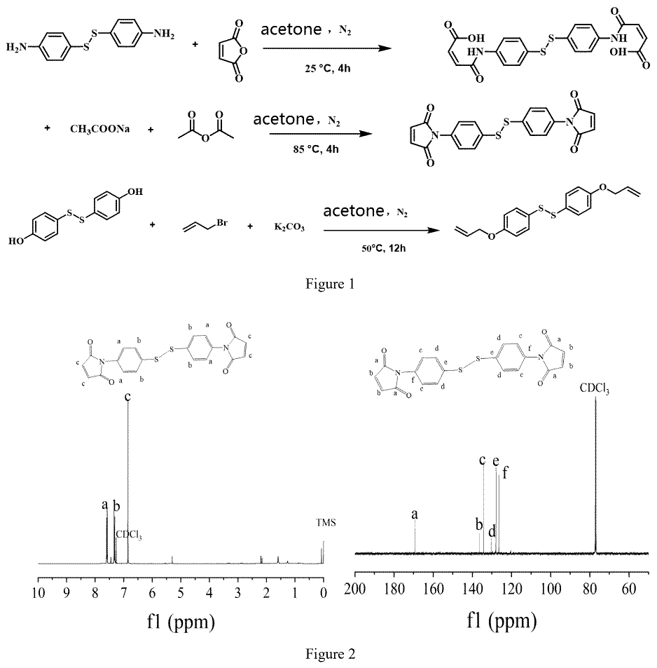

FIG. 1 shows the synthetic reaction equation and chemical structural formula of 4,4′-dithiodianiline bismaleimide and 4,4′-diallyloxy diphenyl disulfide.

### (1) Synthesis of 4,4′-dithiodianiline bismaleimide

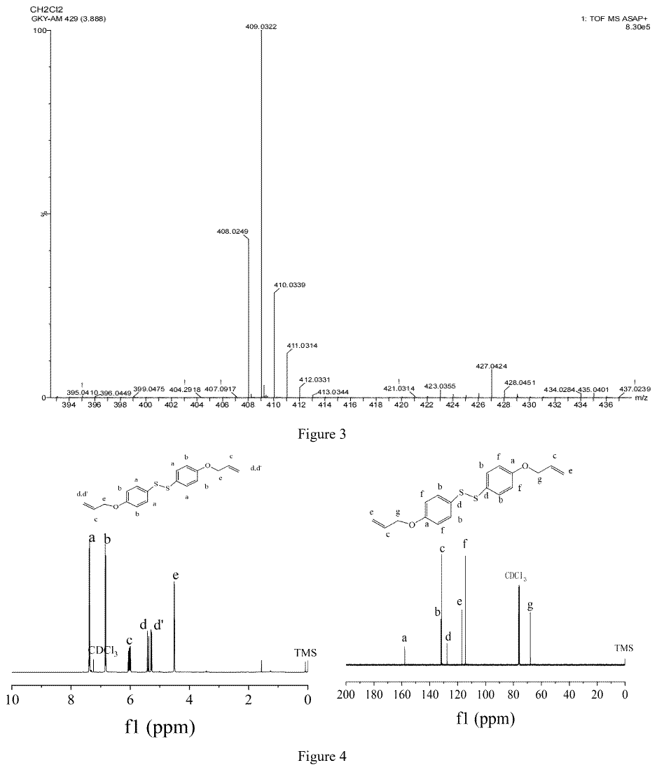

At room temperature, maleic anhydride (6.33 g, 64.6 mmol) was dissolved in acetone (80 mL). Under nitrogen atmosphere, the solution was stirred at room temperature. A mixed solution of 4,4′-dithiodianiline (8.01 g, 32.3 mmol) and acetone (120 mL) was added dropwise through a constant-pressure funnel. After the addition, the mixture was stirred at room temperature for 4 hours. Sodium acetate (2.525 g, 30.75 mmol) and acetic anhydride (25 mL) were then added, and the mixture was stirred under nitrogen atmosphere at 85° C. for 4 hours. Subsequently, the mixture was cooled naturally to room temperature and precipitated in cold water. The solid obtained by suction filtration was washed with a 5% NaHCO₃ solution. The resulting solid was dissolved in dichloromethane (DCM), washed three times with water, and dried with anhydrous MgSO₄. The brown product was concentrated by rotary evaporation to remove the solvent and then routinely dried to yield a yellow powder, identified as 4,4′-dithiodianiline bismaleimide (AM). FIG. 2 shows its ¹H NMR and ¹³C NMR, and FIG. 3 shows its high-resolution mass spectrum.

In the ¹H NMR (CDCl₃) of AM, characteristic peaks can be identified for each hydrogen atom. Specifically, the peak at δ=7.58 ppm corresponds to the four symmetric hydrogen atoms on the benzene ring near the imide ring, the peak at δ=7.34 ppm corresponds to the four symmetric hydrogen atoms on the benzene ring near the disulfide bond, and the peak at δ=6.83 ppm corresponds to the four symmetric hydrogen atoms on the imide ring. In the ¹³C NMR (CDCl₃) of AM, the chemical shifts correspond one-to-one with the carbon atoms in AM. Specifically, the peak at δ=169.23 ppm corresponds to the carbon atom on the C═O bond, the peak at δ=136.43 ppm corresponds to the carbon atom at the double bond in the bismaleimide ring, the peak at δ=126.49 ppm corresponds to the carbon atom on the benzene ring connected to N, the peak at δ=130.40 ppm corresponds to the ortho carbon atom on the benzene ring connected to S the peak at δ=127.98 ppm corresponds to the carbon atom on the benzene ring connected to S, and the peak at δ=134.30 ppm corresponds to the ortho carbon atom on the benzene ring connected to N. The high-resolution mass spectrometry of AM indicates that the measured [M+H⁺] was 409.0322, which is consistent with the theoretical value [M+H⁺] (409.0126).

The above test results prove that 4,4′-dithiodianiline bismaleimide (AM) has been successfully synthesized.

### (2) Synthesis of 4,4′-diallyloxy diphenyl disulfide (DS)

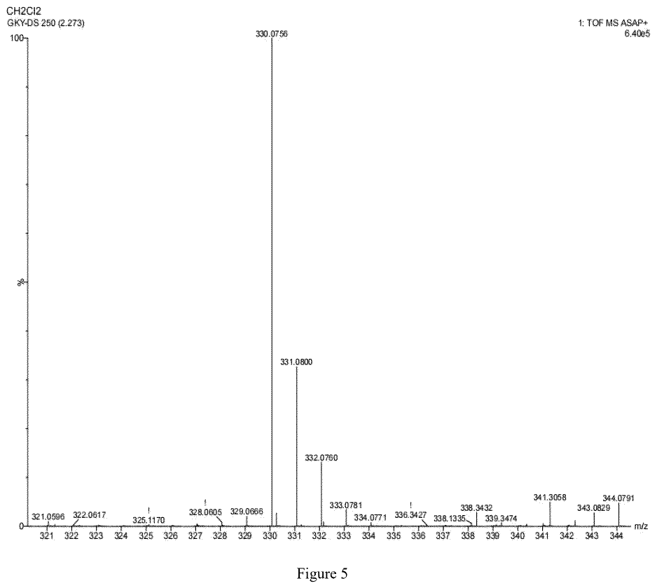

At room temperature, 4,4′-dihydroxydiphenyl disulfide (15.02 g, 60 mmol), anhydrous K₂CO₃ (33.17 g, 240 mmol), and acetone (150 mL) were added to a 250 mL three-neck flask. Under a nitrogen atmosphere, the mixture was stirred while 3-bromoacrolein (21.78 g, 180 mmol) was added dropwise. After the addition was complete, the reaction was continued under magnetic stirring at 50° C. for 12 hours. The solid residue was then filtered out, and acetone along with excess 3-bromoacrolein was removed by rotary evaporation, yielding a clear yellow oily liquid, which was 4,4′-diallyloxy diphenyl disulfide (DS). FIG. 4 shows its ¹H NMR and ¹³C NMR spectra, while FIG. 5 shows its high-resolution mass spectrum.

In the ¹H NMR (CDCl₃) of DS, characteristic peaks can be identified for each hydrogen atom. Specifically, the peak at δ=7.39 ppm corresponds to the hydrogen atom on the benzene ring adjacent to S, the peak at δ=6.85 ppm corresponds to the hydrogen atom on the benzene ring adjacent to O, and the peak at δ=4.50 ppm corresponds to the hydrogen atom on the carbon atom bonded to O. The peaks at δ=6.03 ppm, 5.42 ppm, and 5.29 ppm correspond to the hydrogen atoms on the ═CH-group of the allyl group and the two hydrogen atoms on the ═CH₂ group, respectively. In the 13C NMR spectrum (CDCl₃), the peak at δ=157.87 ppm corresponds to the carbon atom on the benzene ring adjacent to O, the peak at δ=131.87 ppm corresponds to the ortho carbon atom on the benzene ring bonded to S, the peak at δ=114.36 ppm corresponds to the ortho carbon atom on the benzene ring bonded to O, the peak at δ=131.48 ppm corresponds to the CH group on the allyl group, the peak at δ=116.89 ppm corresponds to the CH₂ group on the allyl group, the peak at δ=127.55 ppm corresponds to the carbon atom on the benzene ring adjacent to S, and the peak at δ=67.87 ppm corresponds to the carbon atom on the CH₂ group bonded to O. The high-resolution mass spectrometry of DS indicates that the measured [M+H⁺] was 331.0800, which is consistent with the theoretical value [M+H⁺] (331.0646).

The above test results prove that 4,4′-diallyloxy diphenyl disulfide (DS) has been successfully synthesized.

### Embodiment 1 Preparation of Reprocessable and Degradable Bismaleimide Resin

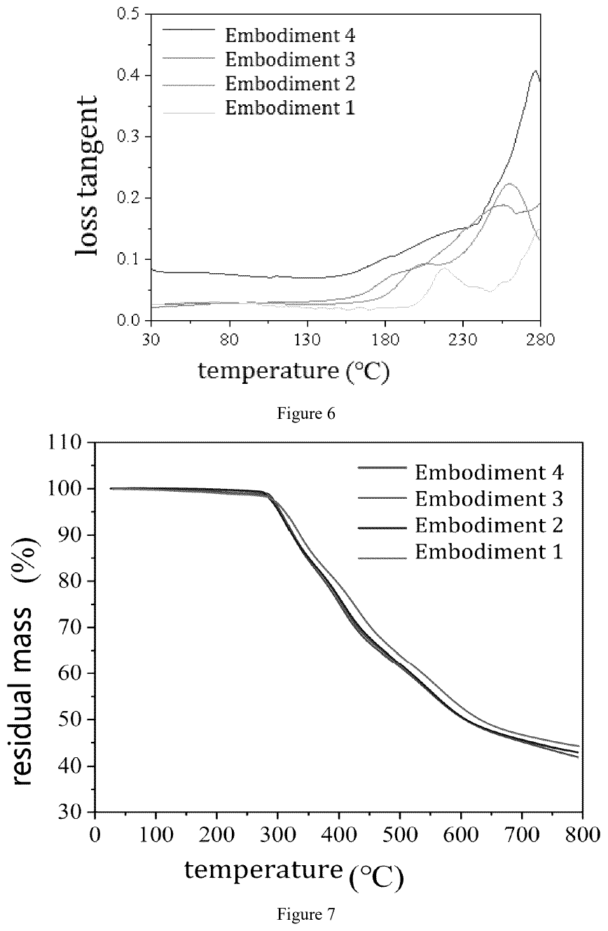

At 150° C., 2 g of phenolphthalein polyarylether ketone was dissolved in 4.105 g of 4,4′-diallyloxy diphenyl disulfide, stirred for 20 minutes, then 5.895 g of 4,4′-dithiodianiline bismaleimide was added at 130° C. The mixture was melt-polymerized at 130° C. for 20 minutes to obtain a prepolymer. The prepolymer was poured into a conventional mold preheated to 150° C., vacuum defoamed at 150° C. for 50 minutes, and then transferred to an oven. The curing process followed the sequence of 150° C./2 h+180° C./2 h+200° C./2 h+220° C./2h, followed by post-curing at 240° C. for 4 hours. The mixture was then naturally cooled to room temperature and demolded to yield the reprocessable and degradable bismaleimide resin (designated as 20cPEK-AD). The loss tangent (Tan δ)-temperature curve, thermogravimetric analysis (TGA) curve, flexural strength histogram, stress relaxation curve, digital photos of the reprocessing process, flexural strength histogram after reprocessing, TGA curve after reprocessing, digital photos before and after degradation, FTIR spectra of the degradation residue and phenolphthalein polyarylether ketone, FTIR spectra of the degraded and recycled solid (deBMI), digital photos of degradation and recycling, and the Tan δ-temperature curve of the degraded and recycled resin (R-deBMI) are shown in FIGS. 6, 7, 8, 9, 10,11,12,13, 14, 15,16, and 17, respectively.

### Embodiment 2 Preparation of Reprocessable and Degradable Bismaleimide Resin

At 150° C., 1.5 g of phenolphthalein polyarylether ketone was dissolved in 4.105 g of 4,4′-diallyloxy diphenyl disulfide, stirred for 20 minutes, then 5.895 g of 4,4′-dithiodianiline bismaleimide was added at 130° C. The mixture was melt-polymerized at 130° C. for 20 minutes to obtain a prepolymer. The prepolymer was poured into a conventional mold preheated to 150° C., vacuum defoamed at 150° C. for 50 minutes, and then transferred to an oven. The curing process followed the sequence of 150° C./2 h+180° C./2 h+200° C./2 h+220° C./2h, followed by post-curing at 240° C. for 4 hours. The mixture was then naturally cooled to room temperature and demolded to yield the reprocessable and degradable bismaleimide resin (designated as 15cPEK-AD). The loss tangent (Tan δ)-temperature curve, thermogravimetric analysis (TGA) curve, flexural strength histogram, stress relaxation curve, flexural strength histogram after reprocessing, TGA curve after reprocessing, digital images before and after degradation, and FTIR spectra of the degradation residue and phenolphthalein polyether ketone are shown in FIGS. 6, 7, 8, 9, 11,12,13, and 14, respectively.

### Embodiment 3 Preparation of Reprocessable and Degradable Bismaleimide Resin

At 150° C., 1 g of phenolphthalein polyarylether ketone was dissolved in 4.105 g of 4,4′-diallyloxy diphenyl disulfide, stirred for 20 minutes, then 5.895 g of 4,4′-dithiodianiline bismaleimide was added at 130° C. The mixture was melt-polymerized at 130° C. for 20 minutes to obtain a prepolymer. The prepolymer was poured into a conventional mold preheated to 150° C., vacuum defoamed at 150° C. for 50 minutes, and then transferred to an oven. The curing process followed the sequence of 150° C./2 h+180° C./2 h+200° C./2 h+220° C./2h, followed by post-curing at 240° C. for 4 hours. The mixture was then naturally cooled to room temperature and demolded to yield the reprocessable and degradable bismaleimide resin (designated as 10cPEK-AD). The loss tangent (Tan δ)-temperature curve, thermogravimetric analysis (TGA) curve, flexural strength histogram after reprocessing, TGA curve after reprocessing, digital images before and after degradation, and FTIR spectra of the degradation residue and phenolphthalein polyether ketone are shown in FIGS. 6, 7, 8, 9, 11, 12,13, and 14, respectively.

### Embodiment 4 Preparation of Reprocessable and Degradable Bismaleimide Resin

At 150° C., 0.5 g of phenolphthalein polyarylether ketone was dissolved in 4.105 g of 4,4′-diallyloxy diphenyl disulfide, stirred for 20 minutes, then 5.895 g of 4,4′-dithiodianiline bismaleimide was added at 130° C. The mixture was melt-polymerized at 130° C. for 20 minutes to obtain a prepolymer. The prepolymer was poured into a conventional mold preheated to 150° C., vacuum defoamed at 150° C. for 50 minutes, and then transferred to an oven. The curing process followed the sequence of 150° C./2 h+180° C./2 h+200° C./2 h+220° C./2h, followed by post-curing at 240° C. for 4 hours. The mixture was then naturally cooled to room temperature and demolded to yield the reprocessable and degradable bismaleimide resin (designated as 5cPEK-AD). The loss tangent (Tan δ)-temperature curve, thermogravimetric analysis (TGA) curve, flexural strength histogram after reprocessing, TGA curve after reprocessing, digital images before and after degradation, and FTIR spectra of the degradation residue and phenolphthalein polyether ketone are shown in FIGS. 6, 7, 8, 9, 11,12,13, and 14, respectively.

As shown in FIG. 6, it shows the loss tangent (Tan δ)-temperature curves of the reprocessable and degradable bismaleimide resins prepared in Embodiments 1-4 of the present invention under an air atmosphere. The peak temperature of Tan δ is typically defined as the glass transition temperature (Tg). Generally, Tg represents the upper service temperature limit of thermosetting resins, and a higher value of Tg indicates better heat resistance of the material. Each curve in the figure exhibits a “main peak+shoulder peak” shape, which is attributed to the multiphase structure present in their network architectures. Through simulated peak fitting, it is demonstrated that each resin possesses two Tg values, with the lower-temperature Tg (Tg₁) exceeding 200° C. (see Table 1). In contrast to prior-art reprocessable and degradable bismaleimide resins whose Tg values are generally below 180° C., the reprocessable and degradable bismaleimide resins described in the present invention exhibit outstanding heat resistance.

As shown in FIG. 7, it shows the TGA curves (10° C./min) of the reprocessable and degradable bismaleimide resin prepared in Embodiments 1-4 of the present invention under nitrogen atmosphere. The initial thermal decomposition temperature (T_{di}, the temperature at 5 wt % weight loss) from these curves is commonly used to evaluate the thermal stability of the resins. As shown in Table 1, as the cPEK content increases, the change in the resin's T_{di} is minimal; however, all values remain higher than the T_{di} of Comparative Example 1 (300.8° C.). This demonstrates that the present invention contributes to improved thermal stability.

TABLE 1
Thermal Stability of Reprocessable and Degradable
Bismaleimide Resins Prepared in Embodiments 1-4

| Resin | Tg1(° C.) | Tg2(° C.) | Tdi (° C.) |
|---|---|---|---|
| Embodiment 1 | 220.8 | 271.1 | 311.9 |
| Embodiment 2 | 208.7 | 261.9 | 302.1 |
| Embodiment 3 | 201.2 | 261.2 | 304.9 |
| Embodiment 4 | 226.7 | 274.2 | 304.7 |

### Comparative Example 1 Preparation of Bismaleimide Resin

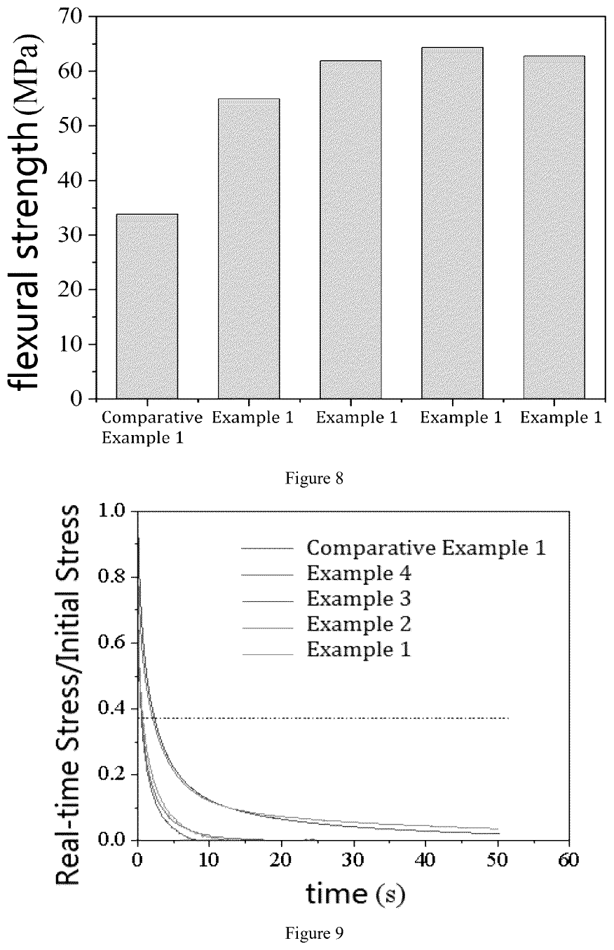

At 130° C., 5.895 g of 4,4′-dithiodianiline bismaleimide was added to 4.105 g of 4,4′-diallyloxy diphenyl disulfide and melt-polymerized for 20 minutes to obtain a prepolymer. The prepolymer was poured into a mold preheated to 150° C., vacuum defoamed at 150° C. for 50 minutes, and then transferred to an oven for curing according to the sequence of 150° C./2 h+180° C./2 h+200° C./2 h+220° C./2h, followed by post-curing at 240° C. for 4 h. After natural cooling to room temperature, the sample was demolded to yield the bismaleimide resin, designated as AD. Its flexural strength histogram, stress relaxation curve, and digital images before and after degradation are shown in FIGS. 8, 9, and 13, respectively.

As shown in FIG. 8, it shows the flexural strength histogram for the reprocessable and degradable bismaleimide resins prepared in Embodiments 1~4 of the present invention, as well as for the bismaleimide resin prepared in Comparative Example 1. Since flexural stress comprises bending, tensile, compressive, and other forms of stress, flexural strength reflects the comprehensive mechanical properties of a resin. As can be seen, the flexural strength of the reprocessable and degradable bismaleimide resins prepared in Embodiments 1~4 is significantly higher than that of the bismaleimide resin from Comparative Example 1, indicating that the resins of the present invention combine high rigidity with excellent toughness.

As shown in FIG. 9, it shows the stress relaxation curves of the reprocessable and degradable bismaleimide resins prepared in Embodiments 1~4 of the present invention, as well as that of the bismaleimide resin prepared in Comparative Example 1. It can be observed that, compared with Comparative Example 1, the reprocessable and degradable bismaleimide resins prepared in Embodiments 1~4 could achieve to 1/e relaxation more rapidly. This indicates that the present invention enhances the segmental mobility of the resin and promotes the exchange reaction of disulfide bonds.

### Embodiment 5: Reprocessing of Reprocessable and Degradable Bismaleimide Resin

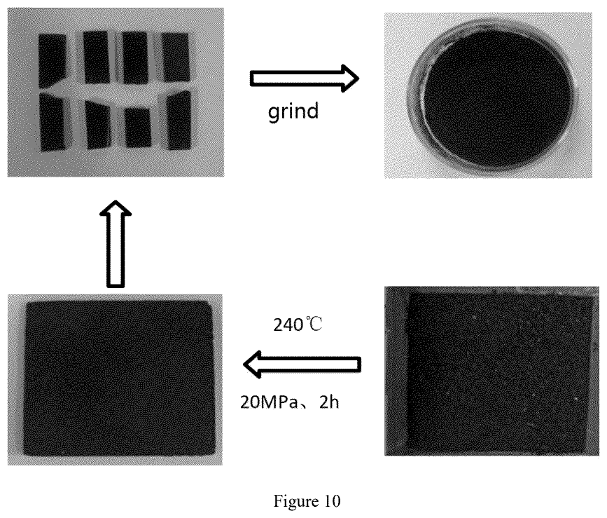

As shown in FIG. 10, it shows digital images of the reprocessing process for the reprocessing and degradable bismaleimide resin prepared in Embodiment 1. The conventionally pulverized bismaleimide resin was hot-pressed at 240° C. under a pressure of 20 MPa for 2 hours. After natural cooling, the sample was demolded to obtain the reprocessed bismaleimide resin, designated as rem-20cPEK-AD. The surface of the rem-20cPEK-AD resin block was smooth and crack-free, indicating that the resin particles underwent dynamic reconnection through a reaction. This result fully demonstrates that the bismaleimide resin prepared in Embodiment 1 can be successfully reprocessed.

Following the method described above, reprocessing experiments were conducted on the 15cPEK-AD, 10cPEK-AD, and 5cPEK-AD resins prepared in Embodiment 2-4, yielding reprocessed resins designated as rem-15cPEK-AD, rem-10cPEK-AD, and rem-5cPEK-AD, respectively.

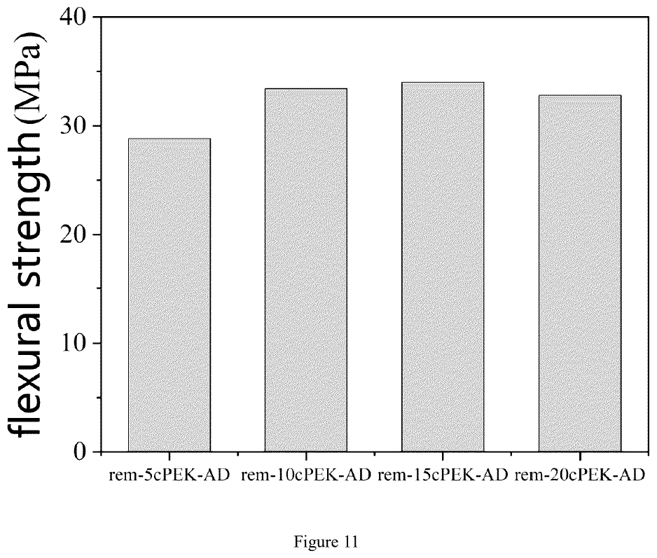

As shown in FIG. 11, it shows the flexural strength histograms of rem-20cPEK-AD, rem-15cPEK-AD, rem-10cPEK-AD, and rem-5cPEK-AD, further demonstrating that the combination of disulfide bismaleimide with phenolphthalein-polyarylene ether ketone enhances the segmental mobility of the resin and promotes the exchange reaction of disulfide bonds, thereby ensuring high mechanical performance of the reprocessed resins.

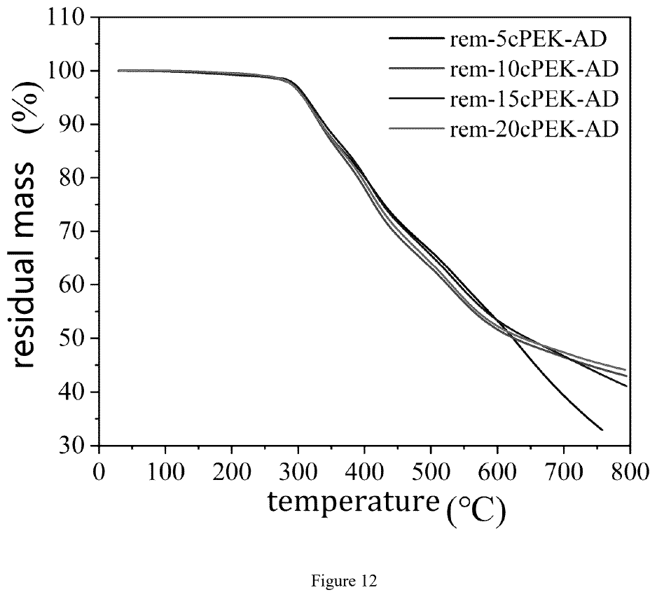

As shown in FIG. 12, it shows the TGA curves of rem-20cPEK-AD, rem-15cPEK-AD, rem-10cPEK-AD, and rem-5cPEK-AD, with the T_{di} values of 307.9, 312.1, 308.1, and 309.5, respectively. By comparing these results with Table 1, it can be observed that the T_{di} of the remolded resins is similar to that of the original resins, indicating that the reprocessing process did not compromise the thermal stability of the original resins.

### Comparative Example 2 Preparation of 4,4′-Diallyloxy Diphenyl Disulfide-Modified Bismaleimide Resin

A clear prepolymer was prepared by mixing 11.15 g (31.1 mmol) of N,N′-4,4′-diphenylmethane bismaleimide with 8.85 g (26.6 mmol) of 4,4′-diallyloxy diphenyl disulfide, which was melt-polymerized at 130° C. for 20 minutes. The prepolymer was then poured into a mold preheated to 150° C., vacuum defoamed at 150° C. for 50 minutes, and then transferred to an oven. The curing process followed the sequence of 150° C./2 h+180° C./2 h+200° C./2 h+220° C./2 h, followed by post-curing at 240° C. for 4 hours. After natural cooling to room temperature, it was demolded to obtain the 4,4′-diallyloxy diphenyl disulfide-modified bismaleimide resin, designated as ABD.

### Embodiment 6 Degradation of Reprocessable and Degradable Bismaleimide Resin

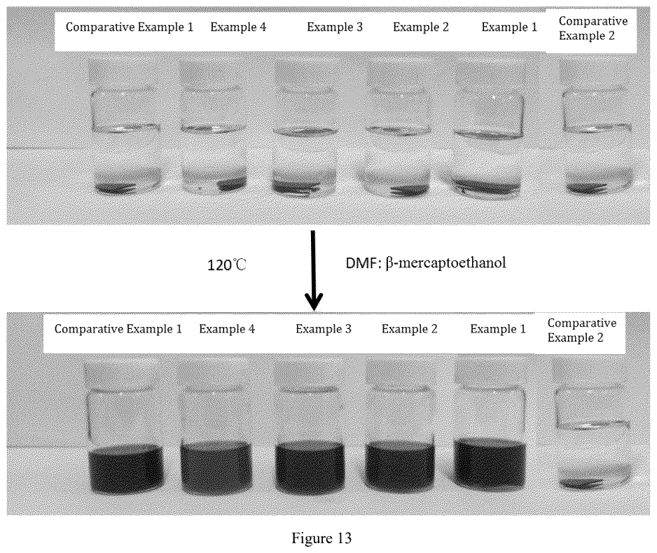

A small piece of resin (120-130 mg) was added to a 10 mL mixture of DMF/β-mercaptoethanol (volume ratio 2:1) at 120° C. with conventional stirring. As shown in FIG. 13, it shows a digital photograph showing the degradation of six resins-20cPEK-AD (Embodiment 1), 15cPEK-AD (Embodiment 2), 10cPEK-AD (Embodiment 3), 5cPEK-AD (Embodiment 4), AD (Comparative Example 1), and ABD (Comparative Example 2)-in the solvent. The BMI resin blocks prepared in Embodiments 1~4 demonstrated rapid degradation efficiency, completely dissolving within 14 min, 18 min, 21 min, and 22 min respectively. The solution color changed from colorless to yellowish-brown, with a small amount of white flocculent material floating at the surface. The solution was filtered to obtain a clear solution A and a white flocculent material B.

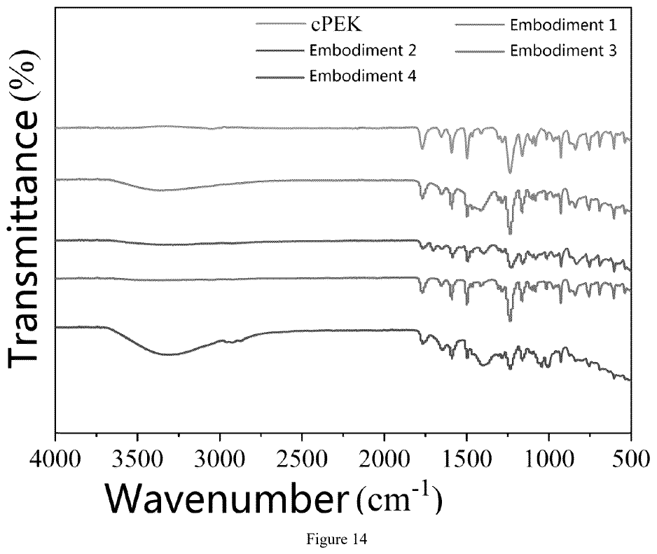

The white flocculent material B obtained from Embodiments 1 to 4 was washed and dried. Its FTIR spectrum matched that of phenolphthalein polyarylether ketone, as shown in FIG. 14, indicating that the white flocculent material B was phenolphthalein polyarylether ketone. Furthermore, the white flocculent material B dissolved completely in dichloromethane at room temperature, indicating that the resin of the present invention can be fully degraded.

The solution A was evaporated at 150° C. to obtain a solid, which was then ground conventionally to yield a solid powder (designated as deBMI).

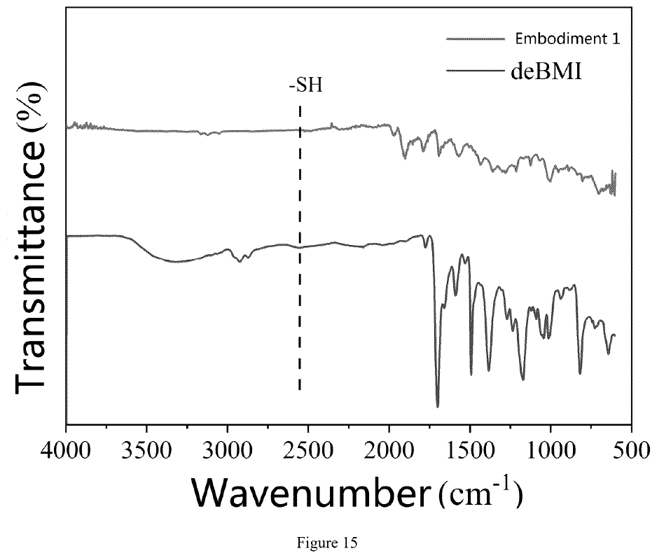

As shown in FIG. 15, it shows the FTIR spectrum of 20cPEK-AD resin prepared in Embodiment 1 of the present invention and its corresponding deBMI. It can be observed that the infrared spectrum of deBMI exhibited a peak at 2555 cm⁻¹ corresponding to the —SH group. This indicates that the disulfide bonds in the bismaleimide resin underwent exchange reactions with the thiols present in the solvent, demonstrating that the 20cPEK-AD resin prepared in Embodiment 1 underwent degradation in the solution, rather than simply dissolving.

The above experiments demonstrate that the BMI resins prepared in Embodiments 1~4 can be completely degraded in solution.

In Comparative Example 1, the AD resin blocks completely dissolved within 65 minutes, with the solvent color changing from colorless to yellowish-brown. This indicates that AD can be degraded in the solvent, but the degradation efficiency is lower than that of the cPEK-AD series resins prepared in Embodiments 1-4. The results indicate that the present invention enhances the segmental mobility of the resin, thereby improving the degradation efficiency.

The ABD resin block prepared in Comparative Example 2 showed no significant changes after 3 hours, indicating it is non-degradable.

The degradation results of the BMI resin in Embodiments 1~4 and Comparative Example 1 show that the degradation is not only related to the content of reversible dynamic bonds, but also depends on segmental mobility of the resin chains.

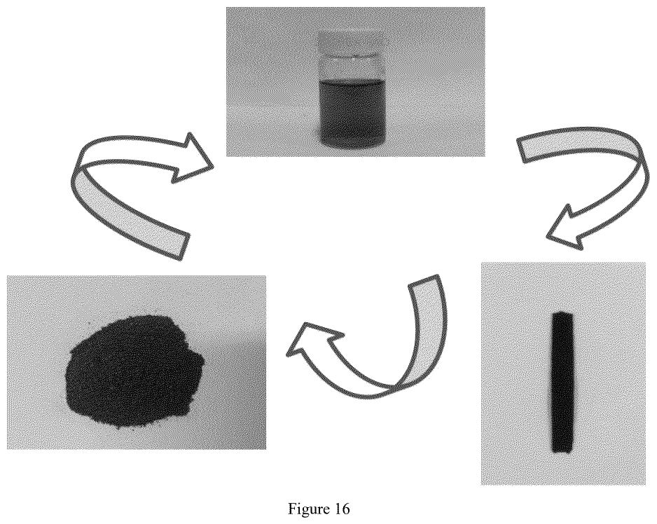

Referring to FIG. 16, it shows digital photographs of the post-degradation compression and recovery process for the 20cPEK-AD resin prepared in Embodiment 1 of the present invention. The solid powder deBMI obtained earlier was hot-pressed at 220° C. under a pressure of 15 MPa for 2 hours to yield the molded and recovered resin, designated as R-deBMI. The surface of R-deBMI was smooth and crack-free, indicating that dynamic disulfide exchange reactions occurred among the resin particles, re-bonding them together. This result fully demonstrates that the bismaleimide resin prepared in the present invention can be recovered through compression after solution degradation.

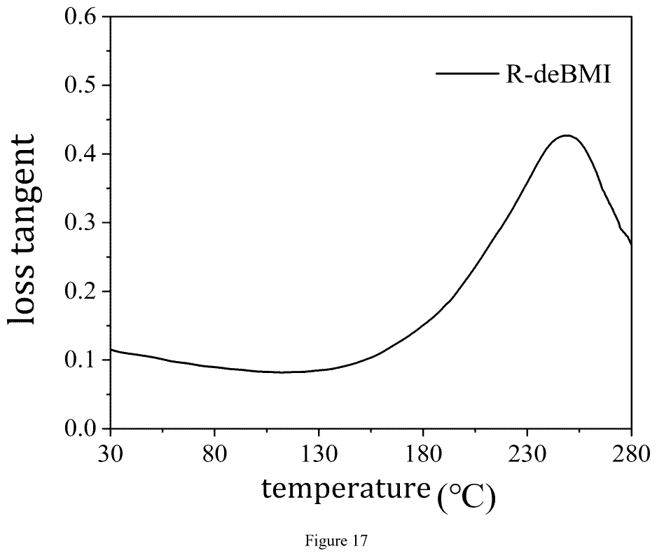

As shown in FIG. 17, this shows the loss tangent (Tan δ)-temperature curve of R-deBMI resin, which was recovered by compression after degradation of 20cPEK-AD resin prepared in Embodiment 1. The results indicate that the Tg of R-deBMI is 250° C., exceeding the Tg values of existing reprocessable and degradable bismaleimide resins.

### Embodiment 7 Preparation of Reprocessable and Degradable Bismaleimide Resin

At 150° C., 2 g of phenolphthalein polyarylether ketone was dissolved in 4.105 g of 4,4′-diallyloxy diphenyl disulfide, stirred for 20 minutes, then 5.895 g of 4,4′-dithiodianiline bismaleimide was added at 130° C. The mixture was melt-polymerized at 130° C. for 20 minutes to obtain a prepolymer. The prepolymer was poured into a conventional mold preheated to 150° C., vacuum defoamed at 140° C. for 50 minutes, and then transferred to an oven. The curing process followed the sequence of 150° C./2 h+180° C./2 h+200° C./2 h+220° C./2h, followed by post-curing at 240° C. for 4 hours. The mixture was then naturally cooled to room temperature and demolded to yield the reprocessable and degradable bismaleimide resin.

### Embodiment 8 Preparation of Reprocessable and Degradable Bismaleimide Resin

At 140° C., 2 g of phenolphthalein polyarylether ketone was dissolved in 4.105 g of 4,4′-diallyloxy diphenyl disulfide, stirred for 20 minutes, then 5.895 g of 4,4′-dithiodianiline bismaleimide was added at 130° C. The mixture was melt-polymerized at 130° C. for 20 minutes to obtain a prepolymer. The prepolymer was poured into a conventional mold preheated to 140° C., vacuum defoamed at 140° C. for 50 minutes, and then transferred to an oven. The curing process followed the sequence of 150° C./2 h+180° C./2 h+200° C./2 h+220° C./2h, followed by post-curing at 240° C. for 4 hours. The mixture was then naturally cooled to room temperature and demolded to yield the reprocessable and degradable bismaleimide resin.

The applicant previously disclosed studies on high-performance reprocessable shape-memory thermosetting resins, reprocessable high-performance bismaleimide resin films, and recyclable thermosetting resins with high heat resistance and strength based on dynamic covalent bonds. Although some of these resins possess reprocessable capabilities, they are generally difficult to degrade in conventional solvents. The present invention discloses a reprocessable and degradable bismaleimide resin, which is prepared through the blending and copolymerization of 4,4′-dithiodianiline bismaleimide (AM), 4,4′-diallyloxy diphenyl disulfide (DS), and phenolphthalein polyarylether ketone. The bismaleimide resin prepared according to the present invention not only exhibits excellent heat resistance but can also be reprocessable under hot-pressing conditions; It achieves rapid and complete degradation in conventional solvents (e.g., a mixed solution of DMF/β-mercaptoethanol), and the degradation solution can be recycled through closed-loop processing by evaporating the solvent, heating, and pressing. This overcomes the limitations of bismaleimide resins containing reversible covalent bonds, which struggle to simultaneously achieve high heat resistance, reprocessable capability, and degradability. The invention provides a novel resin and preparation strategy for the sustainable development of heat-resistant thermosetting resins.

1. A reprocessable and degradable bismaleimide resin, wherein the preparation raw materials include 4,4′-diallyloxy diphenyl disulfide, phenolphthalein polyarylether ketone, and 4,4′-dithiodianiline bismaleimide.

2. The reprocessable and degradable bismaleimide resin according to claim 1, the mass ratio of the monomer to phenolphthalein polyarylether ketone is 1:(0.05-0.2); the monomers are 4,4′-diallyloxy diphenyl disulfide and 4,4′-dithiodianiline bismaleimide, and the molar ratio of 4,4′-diallyloxy diphenyl disulfide to 4,4′-dithiodianiline bismaleimide is (0.5-1): 1.

3. A method for preparing a reprocessable and degradable bismaleimide resin, characterized in that it comprises the following steps: mixing the raw materials for preparing the reprocessable and degradable bismaleimide resin, followed by curing to obtain the reprocessable and degradable bismaleimide resin.

4. The method for preparing the reprocessable and degradable bismaleimide resin according to claim 3, characterized in that, phenolphthalein polyarylether ketone and 4,4′-diallyloxy diphenyl disulfide were mixed at 100-180° C., then 4,4′-dithiodianiline bismaleimide was added and mixed at 100-150° C., and then cured to obtain a reprocessable and degradable bismaleimide resin.

5. The method for preparing the reprocessable and degradable bismaleimide resin according to claim 3, characterized in that, the curing temperature ranged from 150 to 240° C., with a duration of 8 to 15 hours, and the curing process utilized the stepwise heating.

6. A method for preparing a prepolymer of a reprocessable and degradable bismaleimide resin, characterized in that, comprising the following steps: mixing raw materials for preparing the reprocessable and degradable bismaleimide resin to obtain the prepolymer of the reprocessable and degradable bismaleimide resin; The raw materials for preparing the reprocessable and degradable bismaleimide resin include 4,4′-diallyloxy diphenyl disulfide, phenolphthalein polyarylether ketone, and 4,4′-dithiodianiline bismaleimide.

7. The application of the reprocessable and degradable bismaleimide resin according to claim 1 in the preparation or as a bismaleimide resin material.

8. A reprocessing method for the reprocessable and degradable bismaleimide resin according to claim 1, characterized in that, the method includes the following step: subjecting the crushed reprocessable and degradable bismaleimide resin to hot pressing to achieve reprocessing of the resin.

9. A degradation method for the reprocessable and degradable bismaleimide resin according to claim 1, characterized in that, the method includes the following steps: subjecting the reprocessable and degradable bismaleimide resin to a solvent to achieve its degradation.

10. A recycling method for the reprocessable and degradable bismaleimide resin according to claim 1, characterized in that, the method includes the following steps: degrading the resin in a solvent, followed by solvent removal to achieve the recycling.
